(19) United States
(12) Patent Application Publication
(10) Pub. No.: US 2024/0169204 A1
(43) Pub. Date: May 23, 2024

(54) LEARNING METHOD, ESTIMATION METHOD, LEARNING APPARATUS, ESTIMATION APPARATUS, AND PROGRAM

(71) Applicant: NIPPON TELEGRAPH AND TELEPHONE CORPORATION, Tokyo (JP)

(72) Inventor: Tomoharu IWATA, Tokyo (JP)

(21) Appl. No.: 18/548,999

(22) PCT Filed: Mar. 11, 2021
(86) PCT No.: PCT/JP2021/009890

§ 371 Date: Sep. 5, 2023

(51) Int. Cl. G06N 3/08

(52) U.S. Cl. CPC G06N 3/08

(57) ABSTRACT

A learning method executed by a computer including a memory and a processor, that includes: inputting a learning data set including a plurality of pieces of observation data; estimating, by a neural network, parameters of prior distributions of a plurality of pieces of data in a case where the post-missing observation data is expressed by a product of the plurality of pieces of data, using the post-missing observation data in which some values included in the observation data are set as missing values; updating the plurality of pieces of data using the parameters of the prior distributions such that the product of the plurality of pieces of data matches the post-missing observation data; estimating a missing value of the post-missing observation data from the plurality of pieces of updated data; and updating model parameters including parameters of the neural network to increase estimation accuracy of the missing value.

### TECHNICAL FIELD

The present invention relates to a learning method, an estimation method, a learning device, an estimation device, and a program.

### BACKGROUND ART

It is known that, when matrix data including a missing value is given, the missing value can be estimated by matrix decomposition, and this is used in, for example, a recommendation system (for example, refer to Non Patent Literature 1.).

### CITATION LIST

### Non Patent Literature

Non Patent Literature 1: Koren, Y., Bell, R., & Volinsky, C. (2009). Matrix factorization techniques for recommender systems. Computer, 42(8), 30-37.

### SUMMARY OF INVENTION

### Technical Problem

However, a large amount of observation data is required for matrix decomposition. Therefore, in a case where a large amount of observation data cannot be obtained, the missing value cannot be accurately estimated.

An embodiment of the present invention has been made in view of the above points, and an object thereof is to accurately estimate a missing value of matrix data.

### Solution to Problem

In order to achieve the above object, according to an embodiment, there is provided a learning method in which a computer executes an input procedure of inputting a learning data set including a plurality of pieces of observation data, a distribution estimation procedure of estimating, by a neural network, parameters of prior distributions of a plurality of pieces of data in a case where the post-missing observation data is expressed by a product of the plurality of pieces of data, using the post-missing observation data in which some values included in the observation data are set as missing values, a data update procedure of updating the plurality of pieces of data using the parameters of the prior distributions such that the product of the plurality of pieces of data matches the post-missing observation data, a missing value estimation procedure of estimating a missing value of the post-missing observation data from the plurality of pieces of updated data, and a parameter update procedure of updating model parameters including parameters of the neural network to increase estimation accuracy of the missing value.

### Advantageous Effects of Invention

The missing value of the matrix data can be accurately estimated.

### BRIEF DESCRIPTION OF DRAWINGS

FIG. 1 is a diagram illustrating an example of a hardware configuration of a matrix analysis device according to the present embodiment.

FIG. 2 is a diagram illustrating an example of a functional configuration of the matrix analysis device according to the present embodiment.

FIG. 3 is a flowchart illustrating one example of a flow of learning processing according to the present embodiment.

FIG. 4 is a flowchart illustrating one example of a flow of missing value estimation processing according to the present embodiment.

### DESCRIPTION OF EMBODIMENTS

Hereinafter, one embodiment of the present invention will be described. In the present embodiment, a matrix analysis device 10 that can accurately estimate a missing value of unknown matrix data by analyzing a plurality of pieces of matrix data when a plurality of pieces of matrix data is given will be described. Hereinafter, the matrix data is also simply referred to as a “matrix”.

Here, the matrix analysis device 10 according to the present embodiment includes “at the time of learning” for learning parameters (hereinafter the model parameters are referred to as “model parameters”) of a model used for estimating a missing value of an unknown matrix and “at the time of estimation” for estimating a missing value of an unknown matrix using a model in which learned model parameters are set. Note that the “at the time of estimation” may be referred to as, for example, “at the time of test”, “at the time of inference”, or the like.

In the matrix analysis device 10 at the time of learning, a set of D matrices

{X_{d}}_{d=1}^{D} [Math. 1]

is given. This is a set of observed matrix data (that is, observation data).

X_{d}∈ [symbol] ^{N}^{_{d}}^{×M}^{_{d}} [Math. 2]

is the d-th matrix and x_{dnm} represents the value of that (n, m) element. N_{d} and M_{d} are the number of rows and the number of columns of the d-th matrix X_{d}, respectively. D is the number of pieces of matrix data given at the time of learning. D may allow a smaller number than the number of pieces of observation data necessary for estimating the missing value by known matrix decomposition.

Note that a row or a column of a certain matrix in the learning data set may be shared with another matrix or may not be shared. In addition, the matrix may include a missing value.

In order to express a case where a missing value is included in the matrix, a binary matrix

B_{d}∈{0, 1}^{N}^{_{d}}^{×M}^{_{d}} [Math. 3]

is also given. Here, when the value of the (n, m) element of the binary matrix B_{d} is b_{dnm}, it is assumed that a case where b_{dnm}=1 indicates that the (n, m) element of the matrix X_{d} is observed, and a case where b_{dnm}=0 indicates that the (n, m) element of the matrix X_{d} is not observed (that is, the value is missing).

Hereinafter, the set of observation data shown in the above Math. 1 and the set of binary matrices corresponding to this observation data are also referred to as “learning data set”. That is, the learning data set is represented as {(X_{d}, B_{d}); d=1, . . . , D}.

In the matrix analysis device 10 at the time of estimation, a matrix including missing values

X_{*}∈ [symbol] ^{N}^{_{*}}^{×M}^{_{*}} [Math. 4]

and its corresponding binary matrix

B_{*}∈{0, 1}^{N*×M*} [Math. 5]

are given. Here, N* and M* are the number of rows and the number of columns of the matrix X*, respectively. An object is to accurately estimate (that is, the missing value is complemented with high accuracy) the missing value of the matrix X*. Hereinafter, the (X*, B*) is also referred to as “estimation target data”.

Note that, although the matrix is a target in the present embodiment, the present invention is not limited thereto, and can be similarly applied to a tensor. Furthermore, for example, even in the case of data in another form such as a graph or a time series, it is possible to similarly apply the expression to a matrix (or tensor) representing the expression by extracting the expression by deep learning or the like.

### Hardware Configuration of Matrix Analysis Device 10

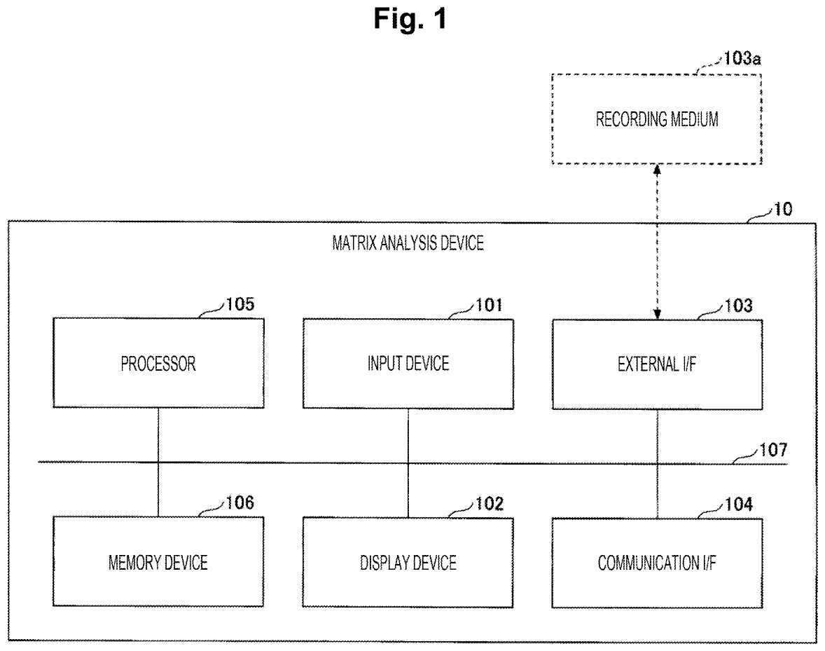

First, a hardware configuration of the matrix analysis device 10 according to the present embodiment will be described with reference to FIG. 1. FIG. 1 is a diagram illustrating an example of a hardware configuration of the matrix analysis device 10 according to the present embodiment.

As illustrated in FIG. 1, the matrix analysis device 10 according to the present embodiment is implemented by a general computer or a computer system, and includes an input device 101, a display device 102, an external I/F (interface) 103, a communication I/F 104, a processor 105, and a memory device 106. These hardware constituents are communicatively connected to each other via a bus 107.

The input device 101 is, for example, a keyboard, a mouse, a touch panel, or the like. The display device 102 is, for example, a display or the like. Note that the matrix analysis device 10 may not include at least either one of the input device 101 and the display device 102.

The external I/F 103 is an interface with an external device such as a recording medium 103a. The matrix analysis device 10 can, for example, read from and write in the recording medium 103a via the external I/F 103. In addition, examples of the recording medium 103a include a compact disc (CD), a digital versatile disk (DVD), a secure digital memory card (SD memory card), a Universal Serial Bus (USB) memory card, and the like.

The communication I/F 104 is an interface for connecting the matrix analysis device 10 to a communication network. The processor 105 is any of various arithmetic devices such as a central processing unit (CPU) and a graphics processing unit (GPU). The memory device 106 is any of various storage devices such as a hard disk drive (HDD), a solid state drive (SSD), a random access memory (RAM), a read only memory (ROM), and a flash memory.

The matrix analysis device 10 according to the present embodiment can implement learning processing and missing value estimation processing to be described later by having the hardware configuration illustrated in FIG. 1. Note that the hardware configuration illustrated in FIG. 1 is an example, and the matrix analysis device 10 may have another hardware configuration. For example, the matrix analysis device 10 may include a plurality of processors 105 or a plurality of memory devices 106.

### Functional Configuration of Matrix Analysis Device 10

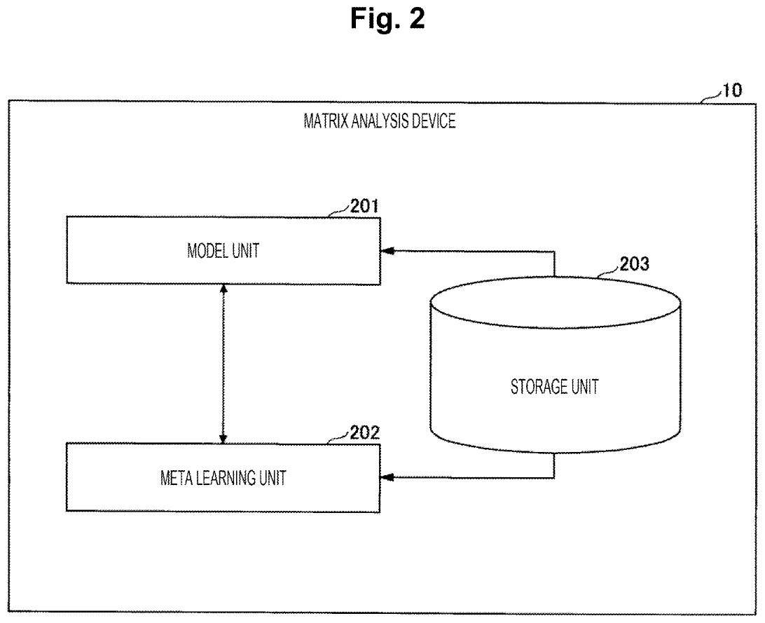

Next, a functional configuration of the matrix analysis device 10 according to the present embodiment will be described with reference to FIG. 2. FIG. 2 is a diagram illustrating an example of a functional configuration of the matrix analysis device 10 according to the present embodiment.

As illustrated in FIG. 2, the matrix analysis device 10 according to the present embodiment includes a model unit 201, a meta learning unit 202, and a storage unit 203. In addition, the model unit 201 and the meta learning unit 202 are implemented, for example, by processing executed by the processor 105 by one or more programs installed in the matrix analysis device 10. Further, the storage unit 203 is implemented by, for example, the memory device 106. However, the storage unit 203 may be implemented by, for example, a database server or the like connected to the matrix analysis device 10 via a communication network.

The model unit 201 estimates a decomposition matrix of the matrix X using the matrix X∈R^{N×M} and the corresponding binary matrix B∈{0, 1}^{N×M} as inputs. Then, the model unit 201 estimates the missing value of the matrix X from these decomposition matrices. Here, at the time of learning, the matrix X and the binary matrix B are the matrix X_{d} and the binary matrix B_{d} included in the learning data set. On the other hand, at the time of estimation, the matrix X and the binary matrix B are the matrix X* and the binary matrix B*.

The model unit 201 estimates the decomposition matrix and the missing value by the following Step 11 to Step 13.

Step 11: First, the model unit 201 calculates parameters of prior distributions of a matrix (hereinafter, the matrix is referred to as a “decomposition matrix”) for matrix-decomposing the matrix X from the matrix X and the binary matrix B using the neural network. Note that any neural network can be used as long as the parameters of the prior distribution of the decomposition matrix can be output from the matrix X and the binary matrix B.

For example, the exchangeable matrix layer is first used to calculate the expression Z∈R^{N×M×C} of the matrix X. When zₙₘ∈R^{C} is an expression of a (n, m) element of the matrix X, the expression Z can be calculated by an exchangeable layer shown in the following Formula (1).

$$\begin{matrix}[ Math . 6 ] & \\ {z}_{nmc}^{( ℓ + 1 )} = σ ( {\sum }_{{c}^{′} = 1}^{{C}^{( ℓ )}} ( {w}_{{c}^{′} c 1}^{( ℓ )} {b}_{nm} z + {w}_{{c}^{′} c 2}^{( ℓ )} \frac{{\sum }_{{n}^{′} = 1}^{N} {b}_{{n}^{′} m} {z}_{{n}^{′} {mc}^{′}}^{( ℓ )}}{{\sum }_{{n}^{′} = 1}^{N} {b}_{{n}^{′} m}} + {w}_{{c}^{′} c 3}^{( ℓ )} \frac{{\sum }_{{m}^{′} = 1}^{M} {b}_{{n m}^{′}} {z}_{{n m}^{′} {c}^{′}}^{( ℓ )}}{{\sum }_{{m}^{′} = 1}^{M} {b}_{{n m}^{′}}} + {w}_{{c}^{′} c 4}^{( ℓ )} \frac{{\sum }_{{n}^{′} , {m}^{′} = 1}^{N , M} {b}_{{n}^{′} {m}^{′}} {z}_{{n}^{′} {m}^{′} {c}^{′}}^{( ℓ )}}{{\sum }_{{n}^{′} , {m}^{′} = 1}^{N , M} {b}_{{n}^{′} {m}^{′}}} + {w}_{c 5}^{( ℓ )} ) ) & ( 1 )\end{matrix}$$

Here, l (l is a lower case L) is an index representing a layer, and 0≤l≤L−1 is set. In addition, z_{nmc}^{(l)} ϵR is an expression of an (n, m) element of the c-th channel in the l-th (l is a lower case L) layer, w_{c′ci}^{(l)}∈R is a weight parameter of the l-th (l is a lower case L) layer, σ is an activation function, and C^{(l)} is the number of channels in the l-th (l is a lower case L) layer. In the first layer (that is, l=0), the given matrix X is the expression. That is, when the value of the (n, m) element of the matrix X is xₙₘ, zₙₘ⁽⁰⁾=xₙₘ∈R. Then, the expression of the last layer is the expression of the matrix X. That is, an expression Z^{(L)} in which z_{nmc}^{(L)}∈R is the (n, m) element of the c-th channel is the expression Z of the matrix X. However, when the expression is calculated in the last layer, the expression is output as it is without using the activation function (that is, the identity function is used as the activation function in the last layer.).

Next, the average value of the prior distribution of the decomposition matrix is estimated by a neural network from the expression Z of the matrix X. For example, the average of the prior distribution of the decomposition matrix can be calculated by the following Formula (2).

$$\begin{matrix}[ Math . 7 ] & \\ {u}_{n}^{( 0 )} = {f}_{U} ( \frac{1}{M} {\sum }_{m = 1}^{M} {z}_{nm} ) , {v}_{m}^{( 0 )} = {f}_{V} ( \frac{1}{N} {\sum }_{n = 1}^{N} {z}_{nm} ) & ( 2 )\end{matrix}$$

Here, assuming that X=UV is matrix-decomposed by U ∈R^{N×K} and V∈R^{K×M}, uₙ⁽⁰⁾∈R^{K} is a vector representing an average of the n-th row of the decomposition matrix U, vₘ⁽⁰⁾∈R^{K} is a vector representing an average of the m-th column of the decomposition matrix V, and f_{U} and f_{V} are neural networks.

As parameters of the prior distributions of the decomposition matrix, not only the average but also the variance may be estimated by the neural network.

Step 12: Next, the model unit 201 updates the decomposition matrices U and V using the parameters of the prior distributions of the decomposition matrix such that the decomposition matrices U and V match the matrix X. This update can be performed by, for example, posterior probability maximization, likelihood maximization, Bayesian estimation, variational Bayesian estimation, or the like.

For example, in the case of the posterior probability maximization, the decomposition matrices U and V can be updated by minimizing E expressed in the following Formula (3) by a gradient method or the like.

$$\begin{matrix}[ Math . 8 ] & \\ E = {\sum }_{n , m = 1}^{N , M} {{b}_{nm} ( {u}_{n}^{⊤} {v}_{m} - {x}_{nm} )}^{2} + λ ( {\sum }_{n = 1}^{N} {‖ {u}_{n} - {u}_{n}^{( 0 )} ‖}^{2} + {\sum }_{m = 1}^{M} {‖ {v}_{m} - {v}_{m}^{( 0 )} ‖}^{2} ) & ( 3 )\end{matrix}$$

Here, γ≥0 is a hyperparameter.

At this time, the update formulas are the following Formulas (4) and (5).

$$\begin{matrix}[ Math . 9 ] & \\ {u}_{n}^{( t + 1 )} = {u}_{n}^{( t )} - η ( {\sum }_{m = 1}^{M} {b}_{nm} ( {u}_{n}^{( t ) ⊤} {v}_{m}^{( t )} - {x}_{nm} ) {v}_{m}^{( t )} + λ ( {u}_{n}^{( t )} - {u}_{n}^{( 0 )} ) ) & ( 4 )\end{matrix}$$

$${v}_{m}^{( t + 1 )} = {v}_{m}^{( t )} - η ( {\sum }_{n = 1}^{N} {b}_{nm} ( {u}_{n}^{( t ) ⊤} {v}_{m}^{( t )} - {x}_{nm} ) {u}_{n}^{( t )} + λ ( {v}_{m}^{( t )} - {v}_{m}^{( 0 )} ) ) \qquad ( 5 )$$

Here, uₙ^{(t)} is a vector representing the n-th row of the decomposition matrix U in the t-th repetition, vₘ^{(t)} is a vector representing the m-th column of the decomposition matrix V in the t-th repetition, and η>0 is a learning rate.

Note that, hereinafter, uₙ^{(t)} and vₘ^{(t)} after the update by the above Formulas (4) and (5) converges are denoted as “uₙ” and “vₘ”, respectively.

Step 13: Then, the model unit 201 estimates the missing value of the matrix X using the decomposition matrices U and V. The missing value of the (n, m) element of the matrix X can be calculated by the following Formula (6).

\hat{x}ₙₘ=uₙ^{T}v_{m . . . (}6) [Math. 10]

The missing value of the matrix X is complemented by estimating the missing value by the above Formula (6).

The meta learning unit 202 learns model parameters. Here, the model parameters include parameters, variance, learning rate, and the like of the neural network (exchangeable matrix layer, fᵤ, fᵥ, and the like).

After initializing the model parameters, the meta learning unit 202 updates the model parameters by a gradient method or the like to increase the estimation accuracy of the missing value by the model unit 201 using each (X_{d}, B_{d}) included in the learning data set.

The storage unit 203 stores a learning data set, a model parameter of a learning target, and the like at the time of learning. On the other hand, the storage unit 203 stores estimation target data, learned model parameters, and the like at the time of estimation.

### Flow of Learning Processing

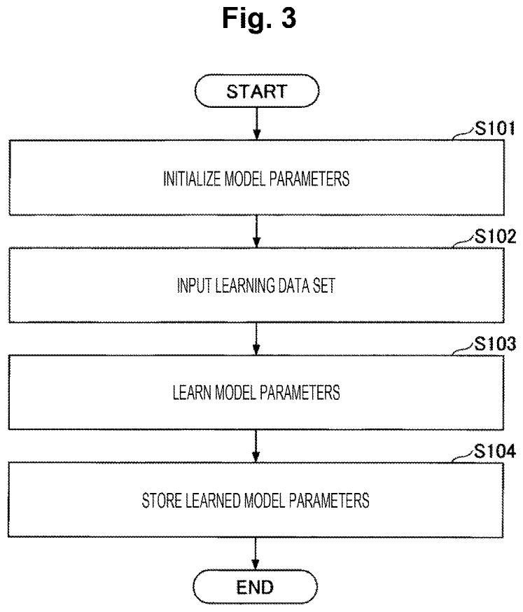

Next, a flow of learning processing executed by the matrix analysis device 10 at the time of learning will be described with reference to FIG. 3. FIG. 3 is a flowchart illustrating one example of the flow of the learning processing according to the present embodiment.

First, the meta learning unit 202 initializes model parameters of a learning target stored in the storage unit 203 (step S101). Note that, for example, the model parameters may be randomly initialized, or may be initialized according to some distribution.

First, the meta learning unit 202 inputs a learning data set stored in the storage unit 203 (step S102).

Next, the meta learning unit 202 learns the model parameters to increase the estimation accuracy of the missing value by the model unit 201 by using each (X_{d}, B_{d}) included in the learning data set input in step S102 described above (step S103). For example, the meta learning unit 202 learns the model parameters by the following Steps 21 to 25.

Step 21: First, the meta learning unit 202 randomly selects one (X_{d}, B_{d}) from the learning data set.

Step 22: Next, the meta learning unit 202 deletes some elements that are not the missing values among the elements of the matrix X_{d} selected in the above Step 21. For example, the n′-th row and the m′-th column are randomly selected, and when b_{n′m′}=1, the (n′, m′) element of the matrix X_{d} is set as the missing value (that is, b_{n′m′}=0 is updated). Note that a plurality of elements may be missing.

Step 23: Next, the model unit 201 uses the matrix X_{d} in which some elements are missing in the above Step 22 and the binary matrix B_{d} thereof as inputs, and estimates the values (missing values) of the elements deleted in the above Step 22 by the above Steps 11 to 13.

Step 24: Subsequently, the meta learning unit 202 updates the model parameters by a gradient method or the like to increase estimation accuracy of the missing value estimated in the above Step 22. Note that, as the estimation accuracy of the missing value, for example, a square error, a negative likelihood, or the like can be used.

Step 25: The meta learning unit 202 repeats the above Steps 21 to 24 until a predetermined end condition is satisfied. Examples of the predetermined end condition include that the values of the model parameters converge and that the number of repetitions of Steps 21 to 24 has reached a predetermined number.

Note that, although one (X_{d}, B_{d}) is selected in the above Step 21, the present invention is not limited thereto, and a plurality of (X_{d}, B_{d}) may be selected, and Steps 22 to 24 may be executed for the plurality of (X_{d}, B_{d}).

Then, the meta learning unit 202 stores the learned model parameters learned in the above Step S103 in the storage unit 203 (Step S104).

### Flow of Missing Value Estimation Processing

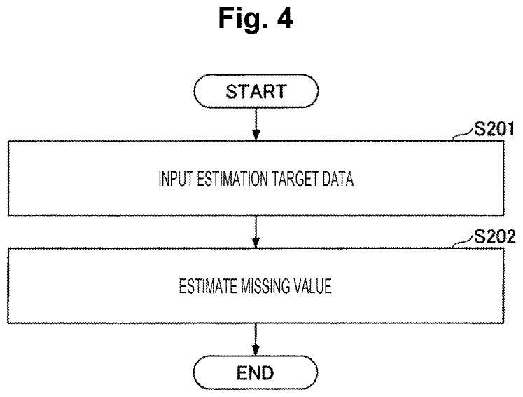

Next, a flow of missing value estimation processing executed by the matrix analysis device 10 at the time of estimation will be described with reference to FIG. 4. FIG. 4 is a flowchart illustrating one example of a flow of missing value estimation processing according to the present embodiment.

First, the model unit 201 inputs the estimation target data (X*, B*) stored in the storage unit 203 (Step S201).

Then, the model unit 201 estimates the missing value of the matrix X , by Steps 11 to 13 using the learned model parameters stored in the storage unit 203 (Step S202). As a result, the missing value of the matrix X* is complemented.

### Evaluation

Next, the accuracy of missing value estimation by the matrix analysis device 10 according to the present embodiment is evaluated. Hereinafter, a method of estimating the missing value by the matrix analysis device 10 according to the present embodiment is referred to as a “proposed method”.

The missing value estimation accuracy of the proposed method and the existing method was evaluated using three data sets (ML 100K, ML1M, Jester). In addition, a test mean square error was adopted as the evaluation index. The evaluation results are shown in Table 1 below.

TABLE 1

| | ML100K | ML1K | Jester |
|---|---|---|---|
| Proposed | 0.901 ± 0.033 | 0.883 ± 0.024 | 0.813 ± 0.009 |
| method | | | |
| EML | 0.933 ± 0.036 | 0.907 ± 0.024 | 0.848 ± 0.009 |
| FT | 1.175 ± 0.047 | 1.149 ± 0.046 | 0.990 ± 0.008 |
| MAML | 0.941 ± 0.036 | 0.904 ± 0.025 | 0.880 ± 0.011 |
| NMF | 0.979 ± 0.034 | 0.972 ± 0.023 | 0.852 ± 0.007 |
| MF | 1.014 ± 0.037 | 0.962 ± 0.031 | 1.005 ± 0.014 |
| Mean | 1.007 ± 0.020 | 0.983 ± 0.013 | 1.004 ± 0.008 |

Here, EML represents a neural network using only an exchangeable matrix layer, FT represents fine tuning, MAML represents model-agnostic meta-learning, NMF represents neural matrix decomposition, MF represents matrix decomposition, and Mean represents a method of complementing a missing value with an average value.

As shown in Table 1 above, the proposed method has a lower missing value estimation error than the existing method. That is, it can be seen that the proposed method can estimate the missing value with higher accuracy than the existing method.

### Conclusion

As described above, the matrix analysis device 10 according to the present embodiment calculates parameters of prior distributions of a decomposition matrix by a neural network, and then uses this parameter to learn model parameters such that the decomposition matrix matches given observation data (matrix data). As a result, it is possible to estimate the missing value of the unknown matrix data with higher accuracy with a smaller number of pieces of observation data than in the conventional method.

Note that, in the present embodiment, as an example, the same matrix analysis device 10 executes the learning processing and the missing value estimation processing, but the present invention is not limited thereto, and for example, the learning processing and the missing value estimation processing may be executed by different devices. That is, for example, the present embodiment may be implemented by a learning device that executes learning processing and an estimation device that executes missing value estimation processing.

The present invention is not limited to the above-mentioned specifically disclosed embodiment, and various modifications and changes, combinations with known technique, and the like can be made without departing from the scope of the claims.

### REFERENCE SIGNS LIST

10 Matrix analysis device
101 Input device
102 Display device
103 External I/F
103a Recording medium
104 Communication I/F
105 Processor
106 Memory device
107 Bus
201 Model unit
202 Meta learning unit
203 Storage unit

1. A learning method executed by a computer including a memory and a processor, the method comprising:
inputting a learning data set including a plurality of pieces of observation data;
estimating, by a neural network, parameters of prior distributions of a plurality of pieces of data in a case where the post-missing observation data is expressed by a product of the plurality of pieces of data, using the post-missing observation data in which some values included in the observation data are set as missing values;
updating the plurality of pieces of data using the parameters of the prior distributions such that the product of the plurality of pieces of data matches the post-missing observation data;
estimating a missing value of the post-missing observation data from the plurality of pieces of updated data; and
updating model parameters including parameters of the neural network to increase estimation accuracy of the missing value.

2. The learning method according to claim 1, wherein the observation data is represented in a matrix form,
upon estimating, by the neural network, the parameters of the prior distributions, the parameters of the prior distributions of two pieces of data are estimated in a case where the post-missing observation data is expressed by a matrix product of the two pieces of data, and
upon updating the plurality of pieces of data, the model parameters are updated using the parameters of the prior distributions such that a matrix product of the two pieces of data matches the post-missing observation data.

3. The learning method according to claim 2, wherein the parameters of the prior distributions include at least an average of values of respective elements of each row constituting first data of the two pieces of data and an average of values of respective elements of each column constituting second data of the two pieces of data.

4. The learning method according to claim 1, wherein
upon updating the plurality of pieces of data, the plurality of pieces of data is updated by posterior probability maximization, likelihood maximization, Bayesian estimation, or variational Bayesian estimation such that a product of the plurality of pieces of data matches the post-missing observation data.

5. An estimation method executed by a computer including a memory and a processor, the method comprising:
inputting estimation target data including a missing value;
estimating parameters of prior distributions of a plurality of pieces of data in a case where the estimation target data is expressed by a product of the plurality of pieces of data by a learned neural network;
updating the plurality of pieces of data using the parameters of the prior distribution such that a product of the plurality of pieces of data matches the estimation target data; and
estimating a missing value of the estimation target data from the plurality of pieces of updated data.

6. A learning device comprising:
a memory; and
a processor configured to:
input a learning data set including a plurality of pieces of observation data;
estimate, by a neural network, parameters of prior distributions of a plurality of pieces of data in a case where the post-missing observation data is expressed by a product of the plurality of pieces of data, using the post-missing observation data in which some values included in the observation data are set as missing values,
update the plurality of pieces of data using the parameters of the prior distributions such that the product of the plurality of pieces of data matches the post-missing observation data;
estimate a missing value of the post-missing observation data from the plurality of pieces of updated data; and
update model parameters including parameters of the neural network to increase estimation accuracy of the missing value.

7. (canceled)

8. A non-transitory computer-readable recording medium having computer-readable instructions stored thereon, which, when executed, cause a computer to execute the learning method according to claim 1.

9. A non-transitory computer-readable recording medium having computer-readable instructions stored thereon, which, when executed, cause a computer to execute the estimation method according to claim 5.
